(19) United States
(12) Patent Application Publication
(10) Pub. No.: US 2011/0232246 A1
(43) Pub. Date: Sep. 29, 2011

(54) Device for Erecting Stalk Crop

(75) Inventors: Michael Müthing, Winterberg (DE); Ralf Paul, Uffenheim (DE)

(73) Assignee: MUTHING GMBH & CO. KG, Winterberg (DE)

(21) Appl. No.: 13/070,047

(22) Filed: Mar. 23, 2011

(30) Foreign Application Priority Data
Mar. 24, 2010 (DE) 10 2010 012 686.1

(51) Int. Cl. A01D 82/00

(52) U.S. Cl. 56/1

(57) ABSTRACT

A device for erecting stalk crop has a holding frame and an erecting tool connected to the holding frame. The erecting tool has a rotatably supported rotation body that has a circular shape and is supported with an outer circumference of the rotational body on a soil surface. The erecting tool has tines that are distributed about the outer circumference of the rotation body and project away from the outer circumference of the rotation body. The tines each have a section projecting past the outer circumference of the rotation body. A longitudinal axis of the sections of the tines is angled at a tine angle relative to the rotational plane of the rotation body.

### BACKGROUND OF THE INVENTION

The invention relates to a device for erecting stalk crop, the device comprising at least one erecting tool arranged on a holding frame.

Modern agriculture is increasingly faced with the problem that the plants or plant stubble of stalk crop during processing on the field are bent by machinery and rolled into the soil. The problem concerns in particular corn plants but also other types of stalk crop. Because the working and transport devices used in agriculture have become heavier and heavier, the width of the wheels of these vehicles has also increased continuously. As a result of different track widths of self-propelled harvesting machines, tractors, and trailers that move next to each other, for example, during harvesting, significant portions of the plant stubble is rolled flat across the working width of the harvesting machine by these vehicles. When the plant residues of the stalk crop that remain on the field, for example, the stubble of corn plants, is to be reworked, for example, in that the stubble is to be mulched or rotary-tilled for killing off pests such as the corn borer, the rolled-flat plant residues or plant residues have been rolled into the soil can no longer be reached by the reworking tools of the reworking devices and the desired reworking effect cannot be achieved across the entire area of the field.

According to a predominant solution, the mulching devices with their rotary tools should erect the harvested crop residues but the results obtained are in reality not satisfactory. The tools of the mulching devices have not proven successful as erecting tools.

### SUMMARY OF THE INVENTION

It is therefore an object of the present invention to provide a device with which bent stalk crop residues or stalk crop residues that have been rolled into the soil can be erected again so that they are accessible again for the tools of the reworking devices to be used subsequently.

In accordance with the present invention, this is achieved in that the erecting tool comprises a rotatably supported rotation body that has a circular shape and is supportable with its outer circumference on the ground and is provided with a number of tines that are attached to the rotation body and project past the circumference of the rotation body and are distributed about the circumference of the rotation body, wherein the longitudinal axis of the tines in their section projecting past the outer circumference of the rotation body are arranged at an tine angle (pitch) relative to the plane of rotation of the rotation body.

The tines are provided in order to first penetrate upon advancing movement of the erecting device in the travel direction partially into the soil in order to be able to engage from below, or at least laterally, plant material that has been rolled deeply into the soil. The rotation body should not, or should only minimally, sink into the soil because no soil working is to be performed. If the soil were to be loosened too much, the stalk crop residues would no longer be sufficiently fixed within the soil in order to be able to carry out a reworking action, for example, flail mowing. When the rotation body sinks too much into the soil, uniform rotational movement can even be impaired. For this reason, the rotation body should have a certain minimum diameter so that the rotation body has a support surface that is sufficiently large to counteract penetration into the soil. The larger the surface of the circular arc that contacts the soil, the smaller the amount of penetration of the rotation body into the soil. Because the circular shape of the rotation body that for a three dimensional body is also realized in a cylindrical shape, the rotation body can roll especially well and uniformly on the soil.

The rotation body serves in particular the purpose of supporting the tines and to move them in rotation. This is possible very well when the rotation body itself is not actively driven but is entrained passively as a result of the advancing movement of the erecting device across the field. The ground contact of the rotation body relative to the ground/soil generates friction by means of which the rotation body is caused to rotate upon forward movement of the device. Because of the tines that are forced into the soil and possibly also by means of the rotation body being slightly pressed into the soil, there is additionally a certain positive-locking connection of the rotation body with the soil by means of which a rotational movement is assisted. Of course, it is also possible to provide the rotation body with a drive action.

When the tips of the tines as a result of the rotation movement have reached their greatest penetration depth in the soil and when they are lifted out of the soil by the continued rotational movement, the tines will also raise the stalk crop residues that are located within the active area of the tines and lift the stalk crop residues out of the soil and/or erect them from the soil. Even when the tines are leaving the soil, they are still acting on the stalk crop residues and continue to lift or erect them until they are laterally gliding off or the tines are moved above the length of the stalk crop residues. As a result, most of the stalk crop residues that have been engaged by the tines have been moved out of the soil and erected from the soil as a result of the contact with the tines so that the stalk crop residues are again accessible for reworking by tools arranged downstream.

As a result of the pitch or tine angle at which the longitudinal axes of the tines in the area of the sections projecting past the outer circumference of the rotation body are positioned relative to the rotation plane of the rotation body, a lateral displacement relative to the rotation body into a free space results which free space is not occupied by the rotation body. In this free space it is easily possible to lift or erect the stalk crop residues without them colliding with the rotation body.

The alignment of the longitudinal axes of the projecting ends (sections) of the tines precisely in radial direction relative the rotational axis of the rotation body or, viewed in the rotational direction, slightly advancing or slightly trailing, has only a minimal effect on the working result of the device. Essentially, the tines effect only a localized lateral penetration or perforation of the soil or ground in order to reach the area below the stalk crop residues. Breaking up of the soil structure or a depth action is not achieved in this way; such a break-up action is to be prevented as much as possible in order to maintain the carrying capacity of the soil for possible subsequent reworking steps and in order to keep the stalk crop residues anchored or fixed sufficiently within the soil.

The number of tines that are attached to the rotation body depends on the diameter of the rotation body, the spacing of the stalk crop residues to be erected relative to each other, and the length of the stalk crop residues to be erected. When the number of tines is too great, this carries the risk that the stalk crop residues are pressed into the soil rather than being erected. When the number of tines is too small, too few of the stalk crop residues across which the device is traveling will be engaged and erected by the tines. For erecting corn stubble, 8-12 tines uniformly distributed about the circumference of the rotation body have been found practical for a diameter of the rotation body of, for example, approximately 50 cm. For a smaller diameter, fewer tines, or for a larger diameter, more times can be provided also, as needed.

According to one embodiment of the invention, the pitch (tine angle) of the tines is 30 degrees to 60 degrees relative to the rotational plane and the tines project by a length of 3 cm to 8 cm past the outer circumference of the rotation body. In this embodiment of the tines an advantageous erecting action results. For a pitch or tine angle that is too small, the tines of the stalk crop residues cannot be engaged and lifted securely enough, and stalk crop residues glide already within the soil laterally past the tines and are not even engaged. For a pitch or tine angle that is too large, the tines will no longer engage below the stalk crop residues but instead force them even deeper into the soil. Moreover, the force required for pushing the tines into the soil below the stalk crop residues increases too much. When the tines are too long, they will dig d own into the soil too much; when they are too short, they will not reach the stalk crop residues that have been pressed into the soil.

According to one embodiment of the invention, the tines have a rounded surface. In particular for a cylindrical shape of the tines a good compromise is achieved between satisfactory stability, loadability and service life of the tines, a minimal force expenditure for forcing the tines into the soil and into an area below the stalk crop residues, and a good engaging and erecting function of the tines relative to the stalk crop residues that can easily glide on the surface of tine, respectively.

According to one embodiment of the invention, the rotation body is embodied as a disk to which the tines are attached. A disk-shaped rotation body is lightweight, can be produced inexpensively, is loadable to a satisfactory extent, and the tines can be easily attached to it. The disk can be flat or may be provided with a convex or concave curvature. A double or twin disk is possible also; in this embodiment the tines are arranged between the two disks. The disk can be embodied as a steel, cast iron or plastics part.

According to one embodiment of the invention, the disk has reinforcement elements. Since the disk is especially loaded mechanically in particular in the areas where the tines are connected to the disk, in these areas thicker material layers, gusset plates, additional sheets or bars or the like may be provided in order to absorb and distribute the loads caused by the tines in the disk across a larger surface area of the disk.

According to one embodiment of the invention, the rotational axis of the disk is positioned at an angle of 10 degrees to 60 degrees relative to the travel direction of the device and/or at an angle of 10 degrees to 45 degrees relative to the horizontal.

The angular positioning of the rotational axis in relation to the travel direction has the effect that the disk has a greater working and action range. The tines penetrate an area of the soil that is laterally displaced transverse to the travel direction to the exit area. With this transverse displacement it is possible to penetrate with the tines the soil in an area where there are no stalk crop residues and, with the simultaneous advancing and rotating movement of the disk, to provide a transverse displacement of the tines in the soil such that the stalk crop residues are engaged from below and upon advancing rotational movement are lifted and erected. When a disk, where the rotational axis is positioned at an angle relative to the travel direction, is moved along a row of harvested crop, for example, a row that is produced when row seeding corn, it is possible to penetrate the soil with the tines closely adjacent to the stubble row, to then engage with the tip of the tine a stubble and to then lift it out of the soil and to erect it.

By displacing the rotational axis relative to the horizontal, depending on the shape of the tines or disk, more beneficial force introduction into the tines or the disk may be achieved or, by means of the elliptical movement path of the tines (viewed in the travel direction) that is caused by the angled positioning, flatter movement profiles of the tines are achieved by means of which an advantageous lifting/erecting function can be achieved. A beneficial force introduction results, for example, for an angled positioning of the disk that causes a pulling action.

According to one embodiment of the invention, the disk is attached to the holding frame so as to be adjustable in longitudinal direction, in transverse direction and/or about the vertical axis as a whole and/or the rotational axis of disk relative to the travel direction and/or the horizontal. By adjustment in longitudinal direction the device can be adjusted relative to the stalk crop, respectively, and/or to tools that are arranged in front or behind. By a transverse adjustment, the device can be matched to various row spacings of stalk crop planted in rows. By an adjustment about the vertical axis a suitable angle of the disk relative to the travel direction can be adjusted.

According to one embodiment of the invention, the disk has correlated therewith a stripping device. When a section of the disk is lifted out of the soil, plant residues or soil may adhere to the disk. When material increasingly collects on the disk, this may impair the function of the device as a whole. In order to prevent such a material deposit, it is advantageous to provide a stripping device that will strip off material adhering to the surface of the disk. The striping device may be arranged in close proximity to the disk so as to extend at one location completely or partially about the radius of the disk wherein, for an arrangement that relative to the radial direction is slightly trailing, a material-deflecting component results by means of which the material that has been removed from the disk is conveyed in outward direction. The stripping device can have a cross-sectional shape that tapers in a direction opposite to the rotational direction of the disk so that a kind of blade is formed with a pointed leading edge.

According to one embodiment of the invention, the device has a skid rail or a movable skid body such as a movable ball. The skid rail provides a depth limitation by means of which soil penetration of the tines and/or the disk that is too deep can be prevented. The skid rail can be height-adjustable, foldable, and/or removable (demountable).

According to one embodiment of the invention, the disk is supported by means of a force storage element on the holding frame. The force storing element can be embodied in various ways and for various purposes. In order to be able to utilize the force storage function, it is advantageous when the disk is connected to the holding frame so as to be moveable relative to the holding frame. In case of a possible joint or hinge connection, a spring or a hydrauliccylinder can be positioned as a force storage device at a location remote from the joint or hinge.

For example, a force storage element can be, for example, embodied as a mechanical spring that serves as an overload safeguard. When forces are acting onto the tines or one or several of the disks secured by the spring which forces may cause damage, this spring upon surpassing a preset force limit allows for a deflection movement of the disk so that the force peaks that are acting are reduced.

Additionally or alternatively, the spring may also serve to realize a ground copying function for one or several disks. When the disk is secured fixedly by means of the holding frame to a set working height, the disk would not be able to follow the dropping soil level when crossing soil depressions when the disk is connected rigidly to the holding frame. When, however, given an appropriate height adjustment of the holding frame, the disk is forced by means of the spring with a given pressure against the ground, the spring would maintain substantially the pressure acting on the disk when the disk moves across a soil depression and is deflected in downward direction as it follows the dropping soil level in response to the pressure force that is acting on it. Despite the deflection movement the disk would continue to lift stalk crop residues from the soil and erect them even within the soil depression, for example, a vehicle track. The device is thus even useful for uneven ground with good erecting function.

Instead of or in addition to a mechanical spring also other force storage devices can be employed, for example, a hydraulic cylinder that is hydraulically loaded and provided with a suitable control unit or sensor-controlled servomotors, even with electric drive. As a force storage device also shape-elastic elements such as rubber blocks or gas bubbles can be used.

According to one embodiment of the invention, on the holding frame several disks are arranged in a staggered sequential arrangement in the travel direction. For example, two disks sequentially arranged in the travel direction can lift sequentially a stalk crop residue twice, leading to an improved working result. Staggering in the travel direction may also include additionally a lateral displacement of the individual staggered systems, for example in order to obtain a greater working width of the device.

According to one embodiment of the invention, on the holding frame several disks are arranged and the rotational axes of the disks are angularly positioned in different orientations relative to the travel direction. Because of the orientation of the axes of rotation in different directions, lifting moments are generated that act differently on the stalk crop residues and this further improves the working action of the device. It is in particular possible, for example, in case of two disks that are staggered in the travel direction behind each other and slightly displaced relative to each other, to position their rotational axes in different directions, for example, to orient one toward the right and the other toward the left relative to the travel direction so that in this way an erecting device is provided that is aligned with one of the stubble rows. This device then engages and lifts the stalk crop residues twice sequentially from opposite directions. With such a device, excellent work results can be obtained.

According to one embodiment of the invention, the device is designed to be mounted at the front end of a tractor together with a reworking device; at the front end together with a reworking device that is laterally positioned on the tractor; laterally on the tractor together with a reworking device; or at the rear on the tractor together with a reworking device. By means of one of these attachment possibilities of the device on the tractor, the stalk crop residues erected by the device of the invention can be immediately reworked; only a single pass across the field must be carried out without the erected stalk crop residues, after having been erected, being rolled over again by a vehicle and again rolled into the soil. As a reworking device, for example, rotary tillers or mulching devices can be used. Therefore, another pass across the field is no longer required for reworking the erected stubble.

According to one embodiment of the invention, the erecting device is integrated into a device for stalk crop processing, for example, a stalk crop comminution (chopping) device such as a mowing device, a mulching device, or a rotary tiller. By integration of the erecting device, it is also possible with a single pass across the field to erect the stalk crop residues as well as to rework or further process them.

It is of no consequence with respect to the invention how the disks in relation to the holding frame are arranged. The disks can be secured from above or can be pushed or pulled, depending on how a realization can be effected for a particular application in view of the given conditions.

It is expressly noted that the afore described advantageous embodiments are combinable individually with the features of the independent claim but also in any suitable combination with each other.

Further modifications and advantageous embodiments of the invention can be taken from the following objective description and the drawings. The invention will be explained in more detail in the following with the aid of one embodiment.

### BRIEF DESCRIPTION OF THE DRAWING

FIG. 1 is a view of an erecting device according to the invention with a single disk.

FIG. 2 is a view of an erecting device according to the invention with two disks.

FIG. 3 shows an erecting device according to the invention with a force storage element.

FIG. 4 shows an erecting device according to the invention for three rows of stalk crop.

FIG. 5 shows a disk arrangement for three stalk crop rows with a spring action for each row.

### DESCRIPTION OF THE PREFERRED EMBODIMENTS

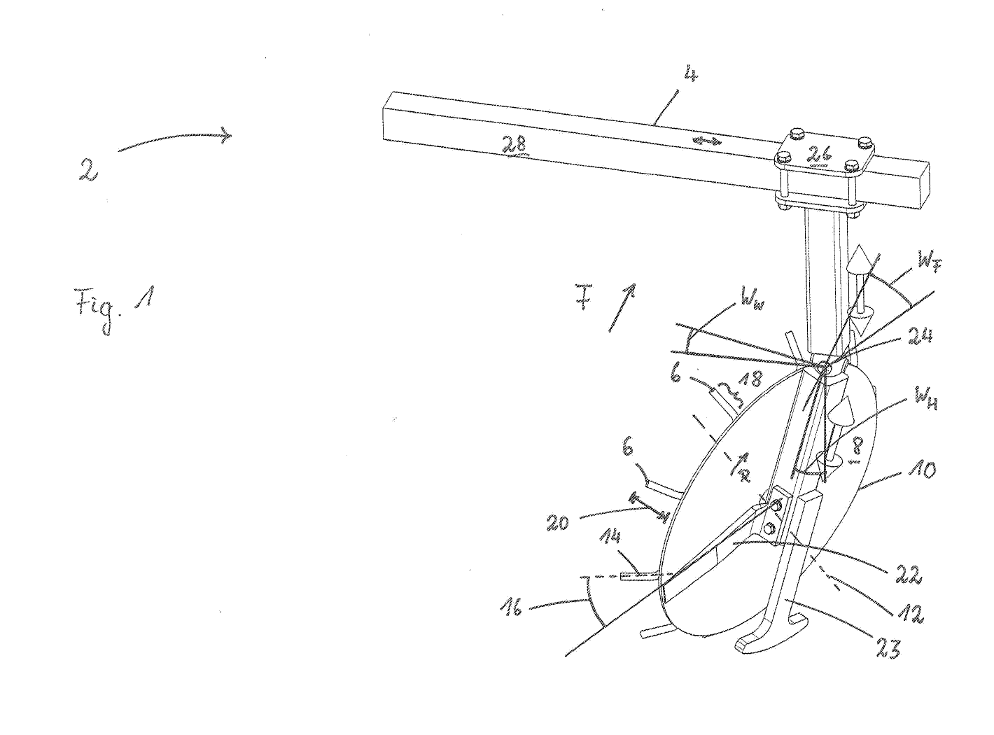

FIG. 1 shows an example of an erecting device 2 according to the invention with a holding frame 4. A disk 8 is connected to the holding frame 4 and has several tines 6 that project past the outer circumference 10 of the disk 8. The disk 8 serves in this embodiment as an illustration for a rotation body. Of course, other shapes of rotation bodies can be employed.

The disk 8 has an axis of rotation 12. When the device 2 is moved in the travel direction F, the disk 8 rotates in passive entrainment about the axis of rotation 12 in rotational direction R once the tines 6 and possibly also the disk 8 have contact with the ground/soil.

As a result of the rotational movement of the disk 8 all tines 6 contact the soil during the course of a complete revolution first at one location. Then, upon continued rotational movement and same spacing of the disk 8 relative to the soil, they are pushed deeper into the soil and to a position below the plant residues, until the fastening point of the tine 6 on the disk 8 has reached the lowest point during a revolution and then, because of the upwardly oriented rotational movement of the disk 8, the tine 6 is pulled out of the soil again and moved away from the soil.

In FIG. 1 it can be seen that the longitudinal axis 14 of the tines 6 with the section 18 with which the tines 6 project past the outer circumference of the disk 8 are arranged at an angle (pitch) 16 relative to the rotational plane of the disk 8. In this way, a lateral displacement 20 of the tips of the section 18 relative to the rotational plane of the disk 8 results. The tines 6 can lift and erect the stalk crop residue into this displacement space during one rotational movement. In the shown embodiment, the tines 6 have within section 18 a cylindrical shape with a circumferentially rounded surface.

In FIG. 1 a stripping device 22 is indicated that extends on one side of the disk 8 transversely along its radius. When material adheres upon rotational movement of the disk 8 to the surface of the disk, the material will collide with the stripping device 22 and will be peeled off the surface of the disk 8. The surface of the disk 8 remains thus free of deposits. Moreover, in FIG. 1 a skid rail 23 is illustrated by means of which the device 2, at least with a portion of its weight, can be supported on the ground; therefore, the disk is relieved by this amount. The skid rail 23 can be designed to be height-adjustable or foldable in order to be able to adjust it better to the respective conditions of use.

In FIG. 1 it can be seen that the axis of rotation 12 of the disk 8 is positioned at an angle W_{F} relative to the travel direction F as well as at an angle W_{W} to the horizontal and at an angle W_{H} to the vertical. The respective angular positions are enabled by the joint 24. The joint 24 can be designed to be adjustable, if needed. Also, a height adjustment is possible as indicated by the double arrow.

On the holding frame 4 there is also a clamping device 26 with which the disk 8 is attached to a transverse support 28 of the holding frame 4. When the clamping device is released, the disk 8 can be moved to the left and to the right along the transverse support 28 transversely to the travel direction F.

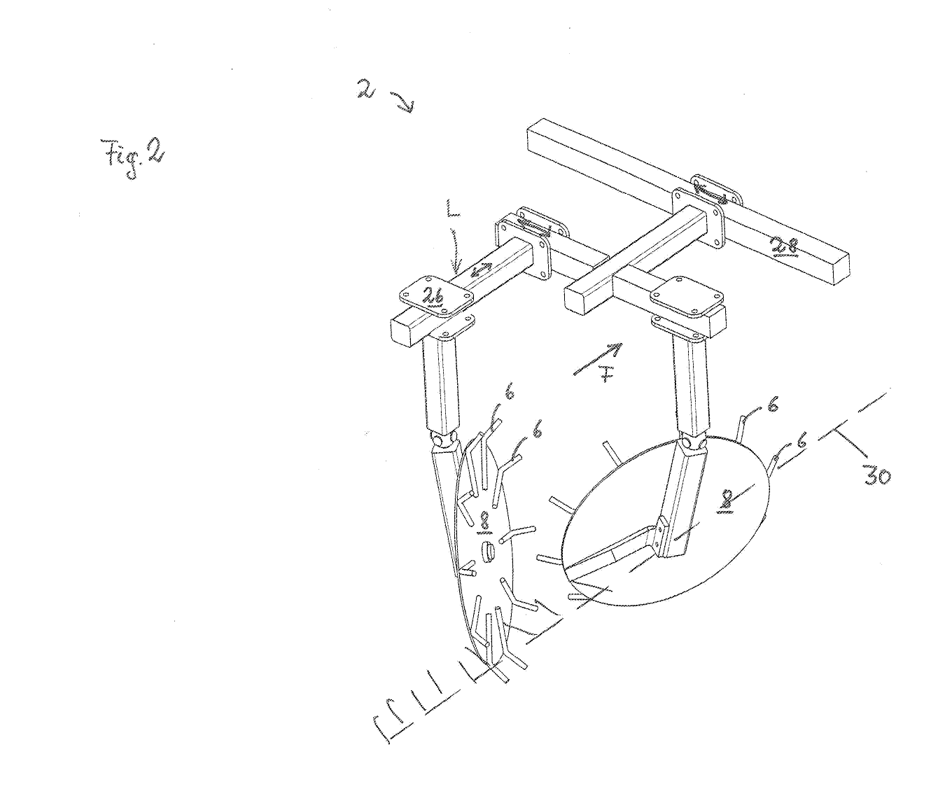

In FIG. 2 a device with two disks 8 is shown. In the travel direction F, the disks 8 are staggered behind each other and are laterally slightly displaced relative to each other in the transverse direction. While the leading one of the two disks 8 in the travel direction F with its leading edge is positioned so as to project to the right at an angle W_{F} to the travel direction F, the rear disk 8 with its leading edge is projecting to the left at an angle W_{F} to the travel direction F. When this device 2 is moved along a stubble row such that the stubble row is positioned precisely between the two disks 8, the stubbles of this stubble row are lifted sequentially by the tines 6 of both disks 8.

Since the clamping device 26 with which the rearward disk 8 is attached on the holding frame 4 engages a longitudinal support L that extends in the travel direction F, the rearward disk 8 after release of the clamping device 26 can be adjusted in longitudinal direction as indicated by the double arrow.

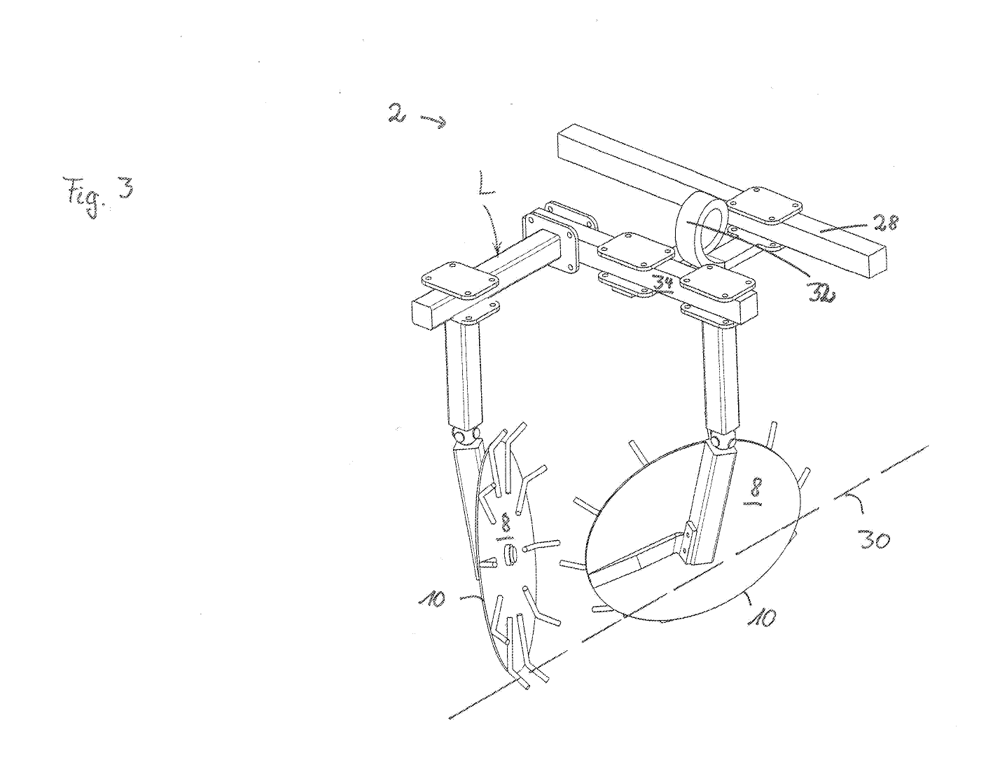

In FIG. 3 between the transverse support 28 and the frame-side receptacle 34 for the two disks 8 a spring 32 as one embodiment of a force storage element is arranged. When the two disks 8 with their outer circumference 10 come into contact with the soil and when the transverse support 28 is pushed, for example, by a three-point hitch of a tractor in downward direction, the relative position of the transverse support 28 and of the receptacle 34 changes and the acting forces are stored in the spring 32. When the disks 8 deflect downwardly, for example, in case of a depression in the ground, the disks 2 are forced by the forces that are stored in the spring 32 into the depression in the ground. In the same way, the spring 32 makes possible also a deflection movement in upward direction when the transverse support 28 remains at the same spacing relative to the ground but a bump on the ground pushes the disks 8 in upward direction. These forces are also taken up by the spring 32 and the thus stored restoring forces return the disks 8 again into their initial position when the forces caused by the bump are eliminated.

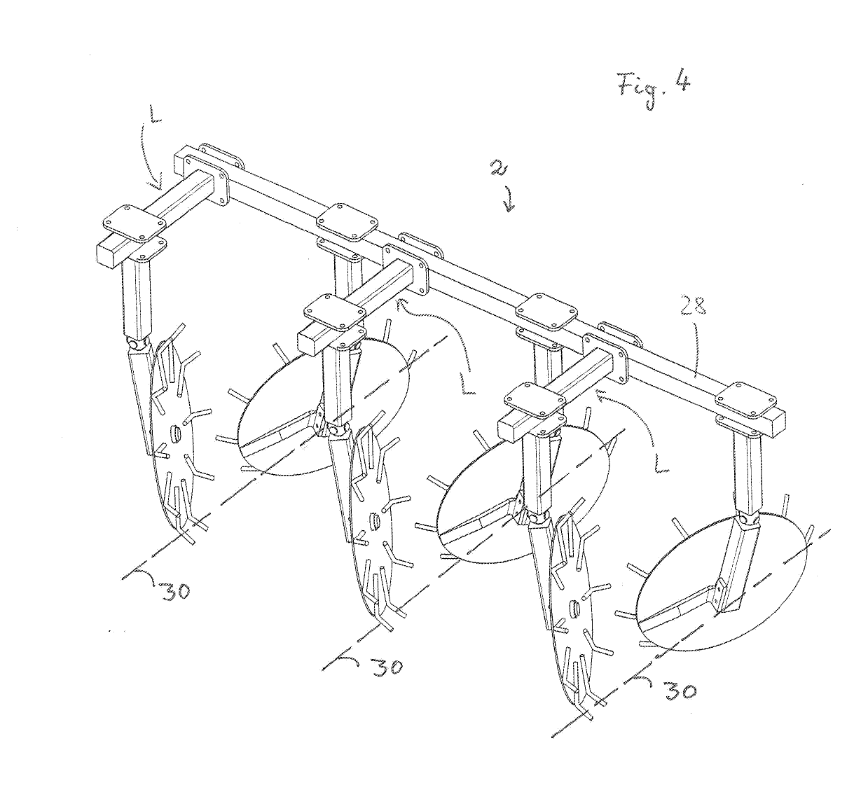

In FIG. 4, a device 2 is shown in which on the transverse support 28 three pairs of disks 8 are attached with which simultaneously three rows 30 of stalk crop can be lifted/erected. In this embodiment the leading disks 8 are attached directly on the transverse support 28 while the rear disks 8 are mounted on a longitudinal support L, respectively.

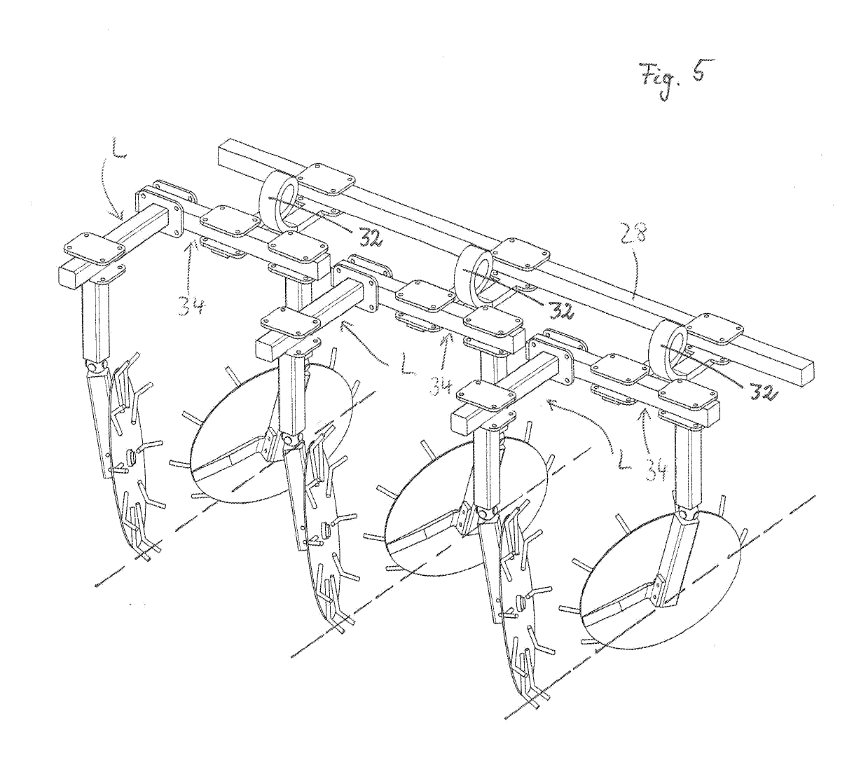

In FIG. 5 an embodiment of the device 2 is shown in which also three pairs of disks 8 are connected to a transverse support 28 but each one of the pairs is provided with its own receptacle 34 that is connected by a spring 32 to transverse support 28. In this way, each of the pairs can adjust individually its relative height to the transverse support 28 according to the respective conditions of the ground. In this way, across the entire working width of the erecting device 2 an optimal adaptation to the contour of the ground is enabled.

The invention is not limited to the afore described embodiments that only serve as an exemplary illustration of the invention. A person skilled in the art is able to modify appropriately the afore described embodiments in a suitable way to a concrete application.

The specification incorporates by reference the entire disclosure of German priority document 10 2010 012 686.1 having a filing date of Mar. 24, 2010.

While specific embodiments of the invention have been shown and described in detail to illustrate the inventive principles, it will be understood that the invention may be embodied otherwise without departing from such principles.

What is claimed is:

1. A device for erecting stalk crop, comprising:
a holding frame;
an erecting tool connected to the holding frame;
wherein the erecting tool comprises a rotatably supported rotation body that has a circular shape and is supported with an outer circumference of the rotational body on a ground surface;
wherein the erecting tool comprises tines that are distributed about the outer circumference of the rotation body and project from the outer circumference of the rotation body;
wherein the tines each have a section projecting past the outer circumference of the rotation body;
wherein a longitudinal axis of the sections of the tines is angled at a tine angle relative to the rotational plane of the rotation body.

2. The device according to claim 1, wherein the tine angle is 30 degrees to 60 degrees relative to the rotational plane of the rotation body and wherein the sections of the tines have a length of 3 cm to 8 cm.

3. The device according to claim 1, wherein the tines have a rounded surface.

4. The device according to claim 1, wherein the rotation body is a disk and the tines are attached to the disk.

5. The device according to claim 4, wherein the disk comprises reinforcement elements.

6. The device according to claim 4, wherein an axis of rotation of the disk is positioned at an angle of 10 degrees to 60 degrees relative to a travel direction of the device.

7. The device according to claim 6, wherein the axis of rotation is positioned at an angle of 10 degrees to 45 degrees relative to the horizontal.

8. The device according to claim 4, wherein the axis of rotation is positioned at an angle of 10 degrees to 45 degrees relative to the horizontal.

9. The device according to claim 4, wherein the disk is connected adjustably on the holding frame and is adjustable by at least one action selected from:
movement in a longitudinal direction extending parallel to a travel direction of the device;
movement in a transverse direction transverse to the travel direction;
rotation about a vertical axis;
displacement of the rotational axis of the disk relative to the travel direction;
displacement of a rotational axis of the disk relative to the horizontal.

10. The device according to claim 4, wherein the disk comprises a stripping device.

11. The device according to claim 1, comprising a skid rail; a removable skid body; or a skid rail and a removable skid body.

12. The device according to claim 1, comprising a force storage device that supports the rotation body on the holding frame.

13. The device according to claim 1, wherein several of said rotation body are connected to the holding frame, wherein said rotation bodies are staggered sequentially in a travel direction of the device.

14. The device according to claim 1, wherein several of said rotation body are connected to the holding frame, wherein said rotation bodies have an axis of rotation and the axes of rotation are oriented in different directions relative to a travel direction of the device.

15. The device according to claim 1, wherein the device is adapted to be mounted:
at a front end of a tractor together with a reworking device;
at the front of the tractor together with a reworking device that is laterally positioned on the tractor;
laterally on the tractor together with a reworking device; or
at the rear on the tractor together with a reworking device.

16. The device according to claim 1, wherein the device is adapted to be integrated into a device for stalk crop processing.
